(19) United States
(12) Patent Application Publication
(10) Pub. No.: US 2011/0313817 A1
(43) Pub. Date: Dec. 22, 2011

(54) KEY PERFORMANCE INDICATOR WEIGHTING

(75) Inventor: DONG HAN WANG, BEIJING (CN)

(73) Assignee: MICROSOFT CORPORATION, REDMOND, WA (US)

(21) Appl. No.: 12/816,869

(22) Filed: Jun. 16, 2010

(51) Int. Cl. G06Q 10/00; G06Q 50/00

(52) U.S. Cl. 705/7.39

(57) ABSTRACT

The relative priorities or weightings of key performance indicators (KPIs) are objectively evaluated for a web service to facilitate determining where efforts should be made in improving the web service. A KPI-taming cost and user engagement variation is determined for each KPI. The KPI-taming cost for a KPI represents a number of engineering man-hours estimated to be required to achieve a unit of KPI improvement for that KPI. The predicted user engagement variation for a KPI represents an improvement in user engagement with the web service estimated to be provided by a certain improvement in that KPI. A KPI-sensitivity is determined for each KPI based on the KPI-taming cost and predicted user engagement variation for each KPI. A weighting may also be determined for each KPI based on the percentage of each KPI's KPI-sensitivity of the sum of KPI-sensitivities for all KPIs.

### BACKGROUND

Web service providers typically evaluate the quality of service provided by their web services in an attempt to identify what improvements to the web services are desirable. Often, this evaluation includes tracking key performance indicators (KPIs) for the web services. Each KPI allows the web service provider to define an area of evaluation and assess the performance of the web service in that area. By way of example, KPIs for a search engine service may relate to, among other things, the search engine's relevance (e.g., a measure of how relevant search results are to end users' search queries), performance (e.g., a measure of how quickly search results are returned after search queries are submitted by end users), and availability (e.g., a measure of how often the search engine service is available to end users).

Tracking KPIs allows web service providers to determine how different areas of their web services are performing and identify areas in which improvements may be made to improve the overall quality of service. Because a number of KPIs are often tracked for a given web service, the KPIs are typically prioritized by defining weightings for each KPI. In other words, weightings for the various KPIs facilitate prioritizing the KPIs to identify which areas of the web service the web service provider should focus efforts on improving the quality of service. Traditionally, a consistent methodology has not been used for determining the weightings for KPIs. Instead, weightings are subjectively defined by certain individuals of the web service provider, which are often business- or marketing-oriented individuals. As a result, the weightings may be arbitrary and vague. Additionally, the individuals who subjectively define the weightings may not have the needed level of understanding to provide weightings that are relatively accurate and adequately address quality of service needs for the web services.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to an objective approach to evaluating key performance indicators (KPIs) for a web service. In embodiments, a KPI-taming cost is determined for each KPI. The KPI-taming cost for a KPI represents the number of engineering man-hours estimated to be required to achieve a unit of KPI improvement for that KPI. Additionally, a predicted user engagement variation is determined for each KPI. The predicted user engagement variation for a KPI is an estimate of an improvement in user engagement with the web service that may be realized given a certain improvement in that KPI. A KPI-sensitivity is determined for each KPI based on the KPI-taming cost and predicted user engagement variation for each KPI. In some embodiments, a weighting is also determined for each KPI. The weighting for a KPI is determined by dividing the KPI-sensitivity for that KPI by the sum of KPI-sensitivities for all KPIs being evaluated for the web service.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a flow diagram showing a method for determining weightings for KPIs in accordance with an embodiment of the present invention;

FIG. 3 is a flow diagram showing a method for calculating a KPI-taming cost for a selected KPI in accordance with an embodiment of the present invention;

FIG. 4 is a graph depicting an exponential curve for KPI-taming cost within a limited KPI range in accordance with an embodiment of the present invention;

FIG. 5 is a flow diagram showing a method for predicting a user engagement variation for a selected KPI in accordance with an embodiment of the present invention;

FIG. 6 is a graph depicting a logarithmic curve for user engagement variation in accordance with an embodiment of the present invention; and

FIG. 7 is a block diagram of an exemplary system in which embodiments of the invention may be employed.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide an objective approach to prioritizing various KPIs being tracked for a web service. This approach is based on the recognition that the impact of improving certain areas of a web service on the overall quality of service varies over the web service's life span. For instance, for a search engine service, at one point in time, improvements in performance would have a greater impact on overall quality of service as compared to improvements in relevance. At another point in time, however, improvements in relevance would have a greater impact on overall quality of service as compared to improvements in performance. Embodiments of the present invention provide an objective approach that facilitates discovering the relative importance of different areas at different times during the web service's life span to help determine where efforts should be placed on improving the web service over its life span.

The goal of improving the quality of service for a web service in embodiments of the present invention is to increase user engagement with the web service. As such, the weighting or relative importance of a KPI in embodiments is based on predicted improvements in user engagement that may be realized if a certain improvement in the KPI is achieved, while also taking into account the engineering costs required to realize the KPI improvement. As such, the weightings provide an objective cost/benefit analysis for prioritizing service improvement efforts.

In accordance with embodiments of the present invention, a number of KPIs are identified for a web service. Each KPI is a measurement that quantifies performance of an area of the web service. Data is mined from the web service to allow each KPI measurement to be tracked over time. In addition to tracking KPI measurements for the web service, information regarding engineering man-hours spent improving the web service is collected over time. User engagement data that reflects user engagement with the web service is also collected over time.

The weighting or relative importance for each of the KPIs is determined based on the historical KPI measurements, historical engineering man-hours, and historical user engagement data tracked for the web service. In embodiments, determining the weighting for a KPI includes determining a KPI-taming cost for the KPI. As used herein, the KPI-taming cost for a KPI represents the engineering man-hours required to obtain a certain improvement in the KPI. The KPI-taming cost for a KPI may be determined by analyzing historical engineering man-hours in conjunction with historical improvements in KPI realized corresponding with those historical engineering man-hours.

In addition to determining a KPI-taming cost for a KPI, a predicted user engagement variation is determined for the KPI. As used herein, the predicted user engagement variation for a KPI represents the extent to which user engagement with the web service is predicted to improve given a certain improvement in the KPI. The predicted user engagement data for a KPI may be determined by analyzing historical user engagement data in conjunction with historical improvements in the KPI.

A KPI-sensitivity is determined for a KPI based on the KPI-taming cost and predicted user engagement variation for that KPI. As such, the KPI-sensitivity for a KPI represents the extent to which the KPI is sensitive to improvements in user engagement based on changes in the KPI taking into account engineering costs required to improve the KPI.

The relative importance of the KPIs is reflected in the KPI-sensitivities. A KPI having a greater KPI-sensitivity can be viewed as presenting an area having a greater potential to impact user engagement if improvements are made. In some embodiments, a weighting may be determined for each KPI based on the KPI-sensitivities. In particular, the weighting for a KPI is the percentage of the KPI's KPI-sensitivity of the sum of KPI-sensitivities for all KPIs being evaluated.

As indicated, the KPI-sensitivities and/or KPI weightings determined in accordance with embodiments of the present invention may be used to evaluate where efforts in improving the web service should be made. Additionally, the KPI-sensitivities and/or KPI weightings may be periodically recalculated at different points of time during the life-cycle of the web service to reevaluate where improvement efforts should be placed. This approach recognizes that different areas of the web service will present better opportunities for improvement relative to other areas at different points in time.

Accordingly, in one embodiment, as aspect of the invention is directed to one or more computer storage media storing computer-useable instructions that, when used by one or more computing devices, cause the one or more computing devices to perform a method. The method includes calculating a KPI-taming cost for each of a plurality of key performance indicators (KPIs) for a web service. The method also includes calculating a predicted user engagement variation for each KPI. The method further includes calculating a KPI-sensitivity for each KPI based on the KPI-taming cost and predicted user engagement variation for each KPI.

In another aspect, an embodiment of the present invention is directed to one or more computer storage media storing computer-useable instructions that, when used by one or more computing devices, cause the one or more computing devices to perform a method. The method includes identifying a plurality of key performance indicators (KPIs) for a web service. The method also includes determining a KPI-taming cost for each KPI, the KPI-taming cost for a given KPI representing a number of engineering man-hours estimated to be required to achieve a unit of KPI improvement for the given KPI. The method further includes determining a predicted user engagement variation for each KPI, the predicted user engagement variation for a given KPI representing an improvement in user engagement with the web service estimated to be provided by an improvement in the given KPI. The method also includes determining a KPI-sensitivity for each KPI, wherein the KPI-sensitivity for a given KPI is determined by dividing the predicted user engagement variation for the given KPI by the KPI-taming cost for the given KPI. The method still further includes determining a weighting for each KPI, wherein the weighting for a given KPI is determined by dividing the KPI-sensitivity for the given KPI by the sum of the KPI-sensitivities for the plurality of KPIs.

A further embodiment of the present in invention is directed to one or more computer storage media storing computer-useable instructions that, when used by one or more computing devices, cause the one or more computing devices to perform a method. The method includes identifying a plurality of key performance indicators (KPIs) for a web service. The method also includes repeating the following until a KPI-sensitivity has been calculated for each of the plurality of KPIs: selecting one of the KPIs to provide a selected KPI; calculating a KPI-taming cost for the selected KPI by identifying a KPI improvement unit for the selected KPI, accessing historical KPI measurement data and historical engineering cost data for the selected KPI, and determining the KPI-taming cost based on the historical KPI measurement data and the historical engineering cost data in accordance with the KPI improvement unit; calculating a predicted user engagement variation for the selected KPI by accessing historical KPI measurement data and historical user engagement data for the selected KPI, fitting the historical KPI measurement data and historical user engagement data into a logarithmic curve, and determining the predicted user engagement variation based on the logarithmic curve; and calculating a KPI-sensitivity for the selected KPI by dividing the predicted user engagement variation by the taming-cost for the selected KPI. The method further includes summing the KPI-sensitivities for the plurality of KPIs to provide a summed KPI-sensitivity. The method still further includes determining a weighting for each KPI by dividing the KPI-sensitivity for each KPI by the summed KPI-sensitivity.

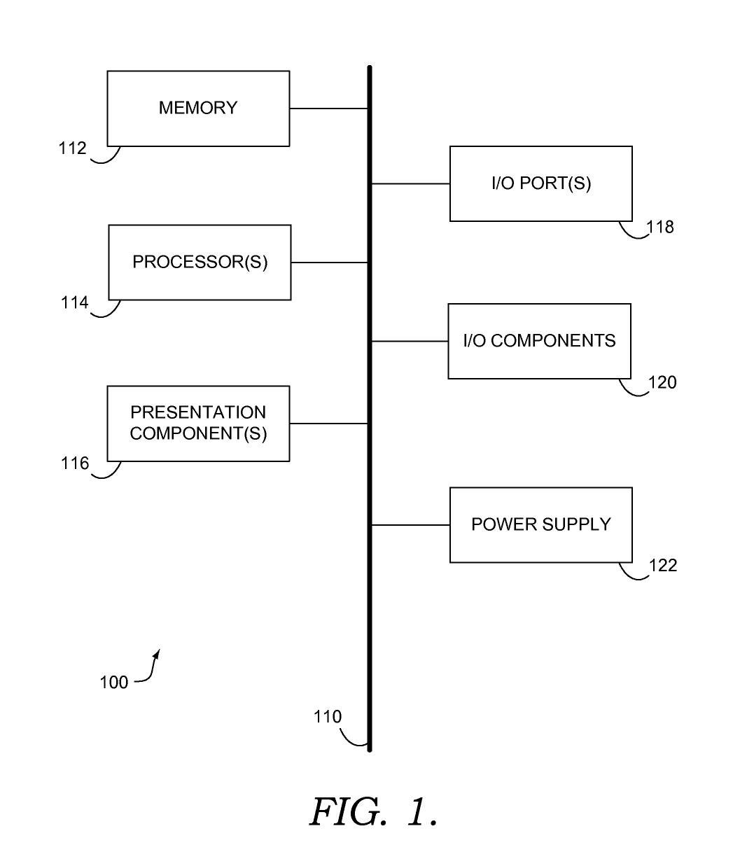

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

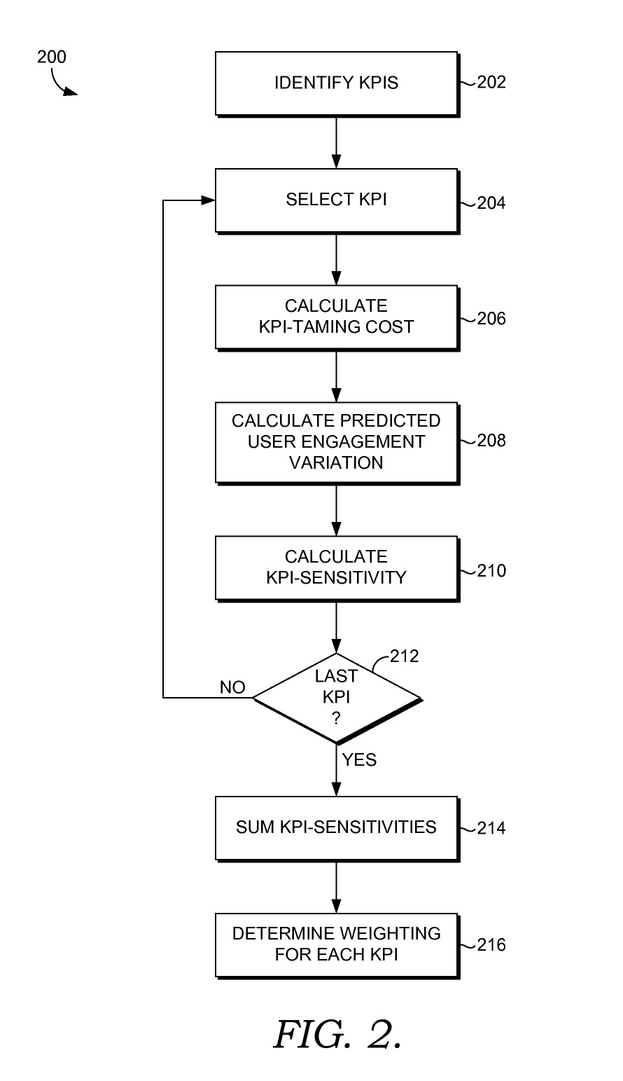

Turning to FIG. 2, a flow diagram is provided that illustrates an overall method 200 for defining weightings for different KPIs considered for quality of service improvement for a web service in accordance with an embodiment of the present invention. Initially, as shown at block 202, KPIs that will be considered for improving the quality of service for a web service are identified. Any number of KPIs may be identified within the scope of embodiments of the present invention. Generally, each KPI is a measure that quantifies performance of an area of the web service. For instance, in the context of a search engine service, KPIs may include a measure of how quickly search results are returned after search queries are submitted by end users or a measure of how often the search engine service is available to end users.

One of the KPIs identified at block 202 is selected for evaluation at block 204. A KPI-taming cost is calculated for the selected KPI, as shown at block 206. As discussed previously, a KPI-taming cost represents the engineering man-hours required to obtain a certain improvement in the KPI. Calculation of the KPI-taming cost in accordance with an embodiment is illustrated in the following equation:

KPI-taming cost=(engineering man-hours)/(1 unit of KPI improvement)

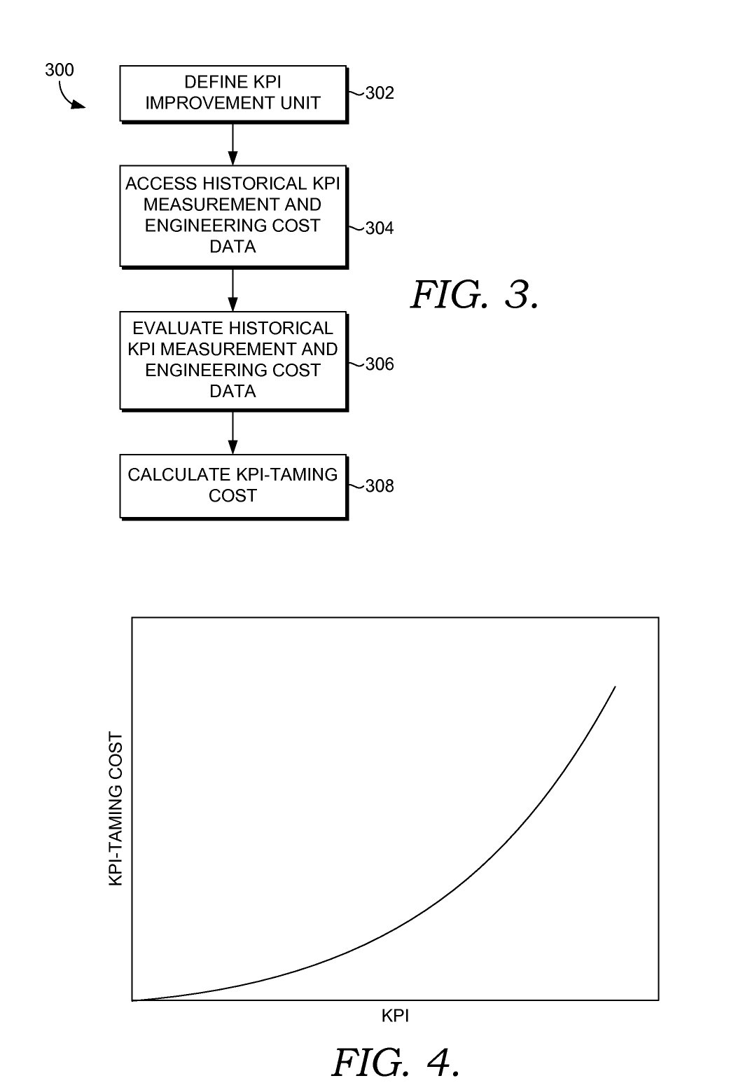

In some embodiments of the present invention, the KPI-taming cost may be calculated for the selected KPI using the method 300 illustrated in FIG. 3. As shown in FIG. 3, a KPI improvement unit is initially defined for the selected KPI, as shown at block 302. The KPI improvement unit may be manually defined via input from individuals of various roles within the web service provider, including, for instance, business owners, operations, and the quality-of-service team.

The KPI improvement unit generally refers to a defined amount of improvement for the KPI. As such, the KPI unit is defined differently for each KPI and is based on the nature of the KPI and the web service. By way of example only and not limitation, a performance KPI for a search engine may track page load times for a search page. The KPI improvement unit for such a KPI may be defined as a 10% decrease in page loading time. As another example, a KPI improvement unit for a KPI related to a search engine service's availability may be defined as a 1% increase in the search engine service's availability.

Historical KPI measurement information and engineering costs are accessed, as shown at block 304. In embodiments, KPI measures may be tracked and logged at various points in time and/or for various releases of the web service. Additionally, the number of engineering-man hours spent working on improvements over certain periods of time and/or between releases may also be tracked. In some instances, engineering man-hours may be allocated to different KPIs. For instance, a different percentage of overall engineering man-hours may be allocated to different KPIs based on an estimate or actual knowledge of the extent to which the engineering man-hours were dedicated to addressing each KPI.

The historical KPI measurement information and engineering-man hours are evaluated at block 306 to determine the number of engineering man-hours required to achieve improvements in KPI. For instance, if the number of engineering-man hours involved in producing a certain release are known and the improvement in KPI from the previous release to the new release are known, the engineering man-hours for that KPI improvement can be determined. The historical information may involve information over a period of time and/or for various releases providing multiple points for determining the engineering man-hours required for certain KPI improvements.

Based on the KPI improvement unit and the evaluation of historical KPI measurement information and associated engineering costs, a KPI-taming cost is determined, as shown at block 308. As noted above, the KPI-taming cost represents the engineering man-hours required to achieve one unit of KPI improvement.

Some embodiments take into account that the KPI-taming cost may vary over a KPI range. Typically, a KPI-taming cost can be expected to have an exponential curve within a limited KPI range, as demonstrated in the graph shown in FIG. 4, for instance. This reflects that as the KPI improves, an increased number of engineering man-hours are required to achieve a same unit of KPI improvement. As such, the KPI-taming cost determined at block 308, in some embodiments, may be based on the most recent measure for the KPI.

Referring again to FIG. 2, in addition to determining the KPI-taming cost for the selected KPI, a predicted user engagement variation is also calculated for the selected KPI, as shown at block 208. As discussed previously, a predicted user engagement variation represents the extent to which user engagement with the web service is predicted to improve given a certain improvement in the KPI.

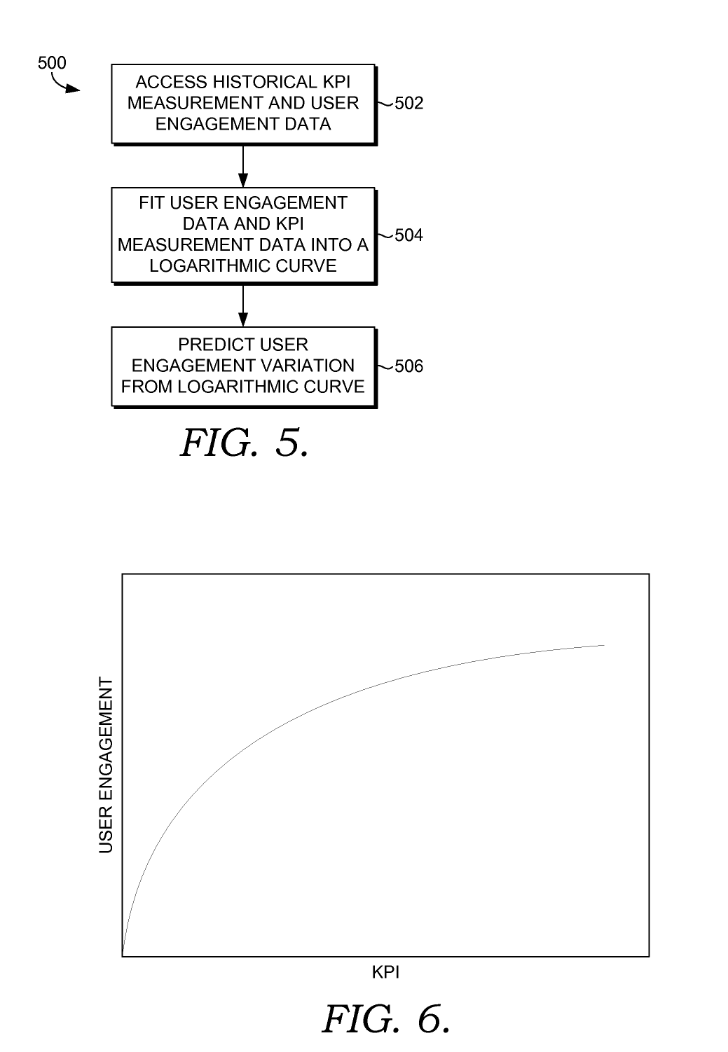

In some embodiments, the predicted user engagement variation may be calculated for the selected KPI using the method 500 illustrated in FIG. 5. The process includes accessing historical user engagement data and historical KPI measurement data, as shown at block 502. User engagement data generally refers to any measure of how users engage the web service. By way of example, in the context of a search engine service, user engagement data may include how frequently users access the search engine. As another example, user engagement data may include user click-through rates on search results on a search results page. As a further example, user engagement data may include user click-through rates on advertisements included on a search results page. User engagement data may be tracked and logged over a period of time and/or for various releases of a web service. Additionally, as noted above, KPI measures may be tracked and logged at various points in time and for various releases of the web service. As such, historical user engagement data and KPI measurement information may be accessed from the logged data.

The user engagement data and KPI measurement information is fit into a logarithmic curve, as shown at block 504. This reflects that as the KPI improves, the relative amount of user engagement improvement for a given amount of KPI improvement will decrease. An example of a logarithmic curve based on historical user engagement data and KPI measurement data fit into a logarithmic curve is demonstrated in the graph shown in FIG. 6.

A user engagement variation is predicted from the logarithmic curve, as shown at block 506. As noted above, the predicted user engagement variation represents the extent to which user engagement with the web service is predicted to improve given a certain improvement in the KPI. In particular, given an assumed improvement in the KPI, the amount of improvement for user engagement corresponding with the assumed improvement in the KPI may be identified from the logarithmic curve.

Returning again to FIG. 2, after determining the KPI-taming cost and predicted user engagement variation for the selected KPI, the KPI-sensitivity is calculated for the selected KPI, as shown at block 210. As discussed previously, a KPI-sensitivity represents the extent to which the selected KPI is sensitive to improvements in user engagement based on changes in the KPI taking into account engineering costs required to improve the KPI. The KPI-sensitivity may be calculated using the following equation:

KPI-sensitivity=(predicted user engagement variation)/(KPI-taming cost)

A KPI sensitivity is determined for each KPI identified at block 202. For instance, as shown in FIG. 2, after calculating the KPI-sensitivity for a currently selected KPI, it is determined at block 212, whether the currently selected KPI is the last KPI to be evaluated. If the currently selected KPI is not the last KPI, the process returns to block 204 to select the next KPI and perform the process of blocks 206, 208, and 210 to calculate the KPI-taming cost, predicted user engagement variation, and KPI-sensitivity for the next selected KPI.

Once it is determined at block 212 that the last KPI has been evaluated, the process continues at block 214 by summing the KPI-sensitivities for all KPIs identified for evaluation at block 202. The weighting for each KPI is determined at block 216. The weighting for a KPI is determined by dividing the KPI-sensitivity for the KPI by the sum of the KPI-sensitivities for all KPIs being evaluated as shown in the following equation:

KPI weighting=(KPI-sensitivity)/sum[KPI-sensitivity]

The KPI sensitivities and/or KPI weightings may be used by the web service provider to objectively evaluate the different areas of the web service and determine which areas present the best opportunities for improving the web service. As such, the web service provider can focus improvement efforts on those areas. In some embodiments of the present invention, the process of calculating KPI sensitivities and/or KPI weightings, such as that shown in FIG. 2, is periodically repeated for the web service. As such, the relative importance of KPIs can be reevaluated at different points in time and a determination may be made at each point regarding what areas present the best opportunities for improvement.

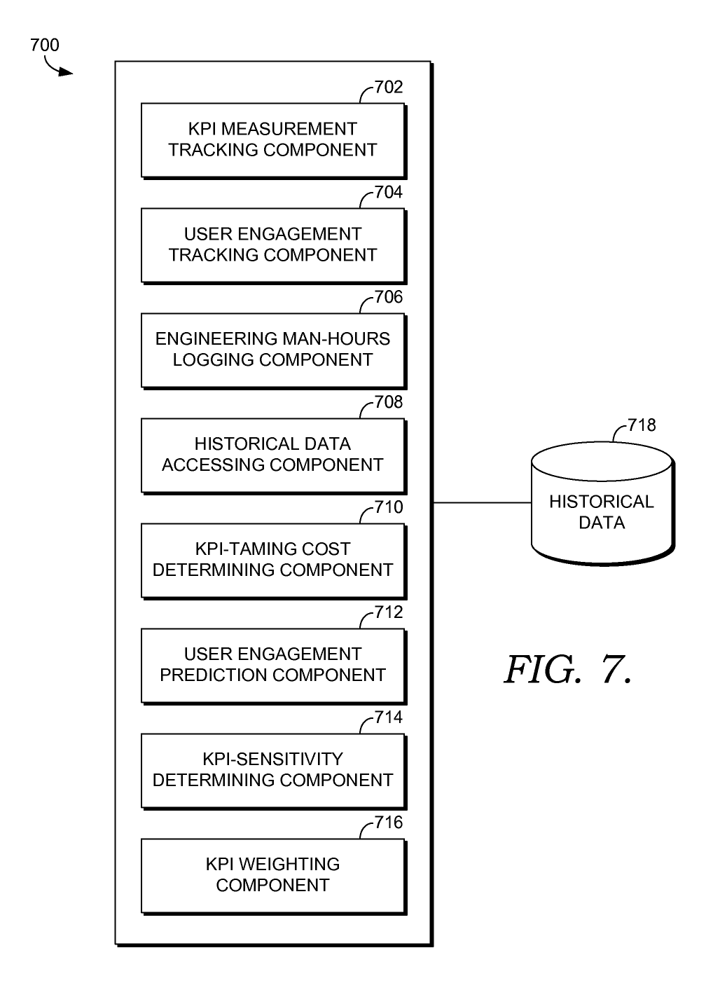

Referring now to FIG. 7, a block diagram is provided illustrated an exemplary system 700 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

As shown in FIG. 7, the system 700 includes, among other components not shown, a KPI measurement tracking component 702, a user engagement tracking component 704, an engineering man-hours logging component 706, a historical data accessing component 708, a KPI-taming cost determining component 710, a user engagement prediction component 712, a KPI-sensitivity determining component 714, a KPI weighting component 716, and a historical data storage 718.

The KPI measurement tracking component 702, user engagement tracking component 704, and engineering man-hours logging component 706 are employed to collect various data, which may be stored in the historical data storage 718. The KPI measurement tracking component 702 tracks data from the web service to determine KPI measurements for each KPI identified to be tracked by the system 700. As such, KPI measurement data is tracked by the KPI tracking component 702 over time and stored in the historical data storage 718. The user engagement tracking component 704 tracks data regarding user engagement with the web service over time and stores the user engagement data in the historical data storage 718. The engineering man-hours logging component 706 may be used to track engineering man-hours spent developing improvements to the web service and to store information regarding the engineering man-hours in the historical data storage 718.

Although only a single historical data storage 718 is shown in FIG. 7, it should be understood that one or more data storages may be provided in various embodiments of the present invention. Additionally, the historical KPI measurement data, user engagement data, and engineering man-hours may be stored together or separately in various embodiments.

The historical data accessing component 708 operates to provide access to historical data stored in the historical data storage 718, including KPI measurement data, user engagement data, and engineering man-hours. Accessed data may be employed by the KPI-taming cost determining component 710 and user engagement predication component 712 to respectively determine the KPI-taming cost and predicted user engagement variation for KPIs.

The KPI-taming cost determining component 710 employs historical engineering man-hour data and historical KPI measurements data accessed from the historical data storage 718 to determine the KPI-taming cost for each KPI being evaluated by the system 700. As discussed above, the KPI-taming cost for a KPI may be calculated by determining the number of engineering man-hours required to achieve a unit of KPI improvement for the KPI.

The user engagement prediction component 712 employs historical user engagement data and historical KPI measurements data accessed from the historical data storage 718 to determine the predicted user engagement variation for each KPI being evaluated. As discussed above, the predicted user engagement variation may be calculated by fitting the historical user engagement data and historical KPI measurements data to a logarithmic curve and determining the predicted user engagement variation from the logarithmic curve.

The KPI-sensitivity component 714 calculates a KPI-sensitivity for each KPI based on the KPI-taming cost and predicted user engagement variation determined for each KPI using the KPI-taming cost determining component 710 and user engagement prediction component 712. In some embodiments, weightings may also be determined for each KPI using the KPI weighting component 716. The weighting for each KPI is determined by dividing the KPI-sensitivity for the KPI by the sum of the KPI-sensitivities for all KPIs being evaluated.

As can be understood, embodiments of the present invention provide an objective approach for evaluating the relative importance of KPIs for a web service. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform a method comprising:
calculating a KPI-taming cost for each of a plurality of key performance indicators (KPIs) for a web service;
calculating a predicted user engagement variation for each KPI; and
calculating a KPI-sensitivity for each KPI based on the KPI-taming cost and predicted user engagement variation for each KPI.

2. The one or more computer storage media of claim 1, wherein calculating a KPI-taming cost for a KPI comprises:
identifying a KPI improvement unit for the KPI; and
calculating the KPI-taming cost based on the KPI improvement unit.

3. The one or more computer storage media of claim 2, wherein calculating the KPI-taming for the KPI further comprises accessing historical KPI measurement data and engineering cost data, and wherein the KPI-taming cost is calculated based on evaluation of the KPI measurement data and the engineering cost data in conjunction with the KPI improvement unit.

4. The one or more computer storage media of claim 1, wherein a KPI-taming cost is calculated for a KPI using the following equation: KPI-taming cost=(engineering man-hours)/(1 unit of KPI improvement).

5. The one or more computer storage media of claim 1, wherein calculating a predicted user engagement variation for a KPI comprises:
accessing historical KPI measurement data;
accessing historical user engagement data; and
determining the predicted user engagement variation based on the historical measurement data and the historical user engagement data.

6. The one or more computer storage media of claim 5, wherein determining the predicted user engagement variation comprises fitting the historical KPI measurement data and historical user engagement data into a logarithmic curve and determining the predicted user engagement variation from the logarithmic curve based on an expected KPI improvement.

7. The one or more computer storage media of claim 1, wherein a KPI-sensitivity is calculated for a KPI using the following equation: KPI-sensitivity=(predicted user engagement variation)/(KPI-taming cost)

8. The one or more computer storage media of claim 1, wherein the method further comprises determining a weighting for each of the plurality of KPIs.

9. The one or more computer storage media of claim 8, wherein the weighting for a given KPI is calculated by dividing the KPI-sensitivity for the given KPI by the sum of KPI-sensitivities for the plurality of KPIs.

10. The one or more computer storage media of claim 1, wherein the method further comprises periodically recalculating a KPI-taming cost, predicted user engagement variation, and KPI-sensitivity for each KPI.

11. The one or more computer storage media of claim 1, wherein the web service comprises a search engine service.

12. One or more computer storage media storing computer-useable instructions that, when used by one or more computing devices, cause the one or more computing devices to perform a method comprising:
identifying a plurality of key performance indicators (KPIs) for a web service;
determining a KPI-taming cost for each KPI, the KPI-taming cost for a given KPI representing a number of engineering man-hours estimated to be required to achieve a unit of KPI improvement for the given KPI;
determining a predicted user engagement variation for each KPI, the predicted user engagement variation for a given KPI representing an improvement in user engagement with the web service estimated to be provided by an improvement in the given KPI;
determining a KPI-sensitivity for each KPI, wherein the KPI-sensitivity for a given KPI is determined by dividing the predicted user engagement variation for the given KPI by the KPI-taming cost for the given KPI; and
determining a weighting for each KPI, wherein the weighting for a given KPI is determined by dividing the KPI-sensitivity for the given KPI by the sum of the KPI-sensitivities for the plurality of KPIs.

13. The one or more computer storage media of claim 12, wherein determining a KPI-taming cost for a KPI comprises accessing historical engineering man-hours data and historical KPI measurement data for the KPI.

14. The one or more computer storage media of claim 13, wherein the KPI-taming cost is determined based on evaluation of the historical KPI measurement data and the historical engineering man-hours data in conjunction with the KPI improvement unit.

15. The one or more computer storage media of claim 12, wherein determining a predicted user engagement variation for a KPI comprises accessing historical KPI measurement data and historical user engagement data.

16. The one or more computer storage media of claim 15, wherein the predicted user engagement variation is determined by fitting the historical KPI measurement data and historical user engagement data into a logarithmic curve and determining the predicted user engagement variation from the logarithmic curve based on an expected KPI improvement

17. The one or more computer storage media of claim 12, wherein the web service comprises a search engine service.

18. One or more computer storage media storing computer-useable instructions that, when used by one or more computing devices, cause the one or more computing devices to perform a method comprising:
identifying a plurality of key performance indicators (KPIs) for a web service;
repeating:
selecting one of the KPIs to provide a selected KPI;
calculating a KPI-taming cost for the selected KPI by identifying a KPI improvement unit for the selected KPI, accessing historical KPI measurement data and historical engineering cost data for the selected KPI, and determining the KPI-taming cost based on the historical KPI measurement data and the historical engineering cost data in accordance with the KPI improvement unit;
calculating a predicted user engagement variation for the selected KPI by accessing historical KPI measurement data and historical user engagement data for the selected KPI, fitting the historical KPI measurement data and historical user engagement data into a logarithmic curve, and determining the predicted user engagement variation based on the logarithmic curve; and
calculating a KPI-sensitivity for the selected KPI by dividing the predicted user engagement variation by the taming-cost for the selected KPI;
until a KPI-sensitivity has been calculated for each of the plurality of KPIs;
summing the KPI-sensitivities for the plurality of KPIs to provide a summed KPI-sensitivity; and
determining a weighting for each KPI by dividing the KPI-sensitivity for each KPI by the summed KPI-sensitivity.

19. The one or more computer storage media of claim 18, wherein the method further comprises periodically recalculating a KPI-taming cost, predicted user engagement variation, and KPI-sensitivity for each KPI.

20. The one or more computer storage media of claim 18, wherein the web service comprises a search engine service.
